(19) United States
(12) Patent Application Publication
(10) Pub. No.: US 2026/0131855 A1
(43) Pub. Date: May 14, 2026

(54) METHODS AND APPARATUS FOR THE COOPERATIVE CONTROL OF A STEER-BY-WIRE STEERING SYSTEM

(71) Applicant: Ford Global Technologies, LLC, Dearborn, MI (US)

(72) Inventors: Oliver Nehls, Düsseldorf (DE); Sergio Codonesu, Aachen (DE); Hannah Denomme, South Lyon, MI (US); Alexander Ein Waldt, Köln (DE)

(21) Appl. No.: 19/359,355

(22) Filed: Oct. 15, 2025

(30) Foreign Application Priority Data
Nov. 13, 2024 (DE) 102024133187.9

(51) Int. Cl. B62D 6/00

(52) U.S. Cl. CPC B62D 6/008

(57) ABSTRACT

The disclosure generally relates to a steer-by-wire steering system for vehicles and, more particularly to, methods and apparatus for the cooperative control of a steer-by-wire steering system. An example steer-by-wire (SBW) steering system for a vehicle includes machine readable instructions, and a control device to execute the machine readable instructions to determine a steering wheel angle of the steering wheel, cause a steering wheel actuator to apply a first feedback torque to the steering wheel based on the steering wheel angle and a target steering wheel angle, based on a user applied torque that is greater than the first feedback torque, cause the steering wheel actuator to apply a second feedback torque to the steering wheel based on the steering wheel angle, the target steering wheel angle, and the user applied torque, and cause the road wheel actuator to steer a vehicle based on the steering wheel angle.

### RELATED APPLICATION

This patent claims priority from DE Patent Application Number 102024133187.9, which was filed on November 13, 2024, and is hereby incorporated by reference in its entirety.

### FIELD OF THE DISCLOSURE

The disclosure generally relates to a steer-by-wire steering system for vehicles and, more particularly, to methods and apparatus for the cooperative control of a steer-by-wire steering system.

### BACKGROUND

Modern vehicle steering systems include advanced functions such as route following functions, through which a path of the vehicle is controlled semi-autonomously or fully autonomously. A driver of the vehicle can regain manual control of the vehicle by interacting with the steering system.

### SUMMARY

An example steer-by-wire (SBW) steering system for a vehicle comprising a steering wheel, a steering wheel actuator coupled to the steering wheel, a road wheel actuator coupled to road wheels of the vehicle, machine readable instructions, and a control device to execute the machine readable instructions to determine a steering wheel angle of the steering wheel, cause the steering wheel actuator to apply a first feedback torque to the steering wheel based on the steering wheel angle and a target steering wheel angle, based on a user applied torque that is greater than the first feedback torque, cause the steering wheel actuator to apply a second feedback torque to the steering wheel based on the steering wheel angle, the target steering wheel angle, and the user applied torque, and cause the road wheel actuator to steer the vehicle based on the steering wheel angle.

An example non-transitory computer readable medium comprising instructions to cause programmable circuitry to at least determine a steering wheel angle of a steering wheel of a vehicle, cause a steering wheel actuator of the vehicle to apply a first feedback torque to the steering wheel based on the steering wheel angle and a target steering wheel angle, based on a user applied torque that is greater than the first feedback torque, cause the steering wheel actuator to apply a second feedback torque to the steering wheel based on the steering wheel angle, the target steering wheel angle, and the user applied torque, and cause a road wheel actuator of the vehicle to steer the vehicle based on the steering wheel angle.

An example method for operating a steer-by-wire (SBW) steering system comprising determining a steering wheel angle of a steering wheel of a vehicle, causing a steering wheel actuator of the vehicle to apply a first feedback torque to the steering wheel based on the steering wheel angle and a target steering wheel angle, based on a user applied torque that is greater than the first feedback torque, causing the steering wheel actuator to apply a second feedback torque to the steering wheel based on the steering wheel angle, the target steering wheel angle, and the user applied torque, and causing a road wheel actuator of the vehicle to steer the vehicle based on the steering wheel angle.

### BRIEF DESCRIPTION OF DRAWINGS

FIG. 1 shows a schematic representation of a vehicle including a steer-by-wire (SBW) steering system according to examples described herein.

FIG. 2 is a flowchart representative of example machine readable instructions and/or example operations that may be executed, instantiated, and/or performed by example programmable circuitry to implement the SBW steering system of FIG. 1.

FIG. 3 is a flowchart representative of example machine readable instructions and/or example operations that may be executed, instantiated, and/or performed by example programmable circuitry to implement the SBW steering system of FIG. 1.

FIG. 4 shows a schematic representation of an angle and torque curve of an example cooperative control system without a target value correction function.

FIG. 5 shows a schematic representation of an angle and torque curve of a cooperative control system with a target value correction function.

FIG. 6 shows a schematic representation of an angle and torque curve of a cooperative control system in a manual mode and a cooperative steering feel mode.

FIG. 7 is a block diagram of an example processing platform including programmable circuitry structured to execute, instantiate, and/or perform the example machine readable instructions and/or perform the example operations of FIGS. 2 and 3 to implement the steer-by-wire steering system of FIG. 1.

In general, the same reference numbers will be used throughout the drawing and accompanying written description to refer to the same or like parts. The figures are not necessarily to scale.

### DETAILED DESCRIPTION

Modern vehicles often include advanced features (e.g., functions) which enable autonomous or semi-autonomous driving. Known solutions offer different methods for a driver of the vehicle to regain manual control of a steering system of the vehicle. In one known example, the driver can cancel the autonomous function completely, for example, by pressing a switch, pressing the speed reduction pedal (e.g., brake pedal), or applying torque to the steering wheel that is greater than a predetermined torque threshold. In other known examples, the driver can, by applying a desired steering wheel angle, cause a temporary override of an angle target of the steering wheel, which is defined by a path following function. When the driver releases the steering wheel, the vehicle then follows the angle target defined by the route following function. The possibility of influencing the lateral control of the vehicle without completely terminating (e.g., canceling) autonomous control of the vehicle is generally referred to as cooperative control.

Additionally, modern vehicles often feature steer-by-wire (SBW) steering systems. SBW steering systems eliminate the direct mechanical connection between the steering wheel and the road wheel. SBW steering systems utilize at least two actuators, a steering wheel actuator, which generates feedback torque for the driver on the steering wheel, and a road wheel actuator, which regulates at least one, but typically several, steerable road wheels to a desired position. The feedback torque provides the driver feedback regarding the lateral control of the vehicle. To determine the feedback torque corresponding to the lateral control of the vehicle, the SBW steering system includes a control device that executes a feedback algorithm for this purpose.

Because SBW steering systems differ considerably from previous mechanically coupled steering systems, such as electric power steering (EPS) systems, for example with regard to a possible independent control of the steering wheel and road wheels, the previous approaches of cooperative control are not easily transferable.

There is therefore a need to be able to use SBW steering systems within the framework of cooperative control. There is a need to make steering inputs simultaneously by the driver and according to the route following function, whereby the vehicle lateral control should be regulated according to a smooth transition between these input methods to increase comfort for the driver compared to previous approaches.

Examples described herein provide a method for the cooperative control of a SBW steering system of a vehicle. The SBW steering system includes at least one steering wheel, a steering wheel actuator coupled to the steering wheel, a steering wheel sensor, a road wheel actuator coupled to at least one steerable road wheel of the vehicle, and a control device. The control device is at least coupled with the steering wheel actuator, the steering wheel sensor, and the road wheel actuator. The control device executes at least one algorithm for controlling the steering wheel actuator and for regulating the road wheel actuator and is coupled with a vehicle control device. The vehicle control device performs at least a partial or fully automatic route following functionality. The method includes at least the following operations. In a first operation, a target angle for the steering wheel is received by the control device from the vehicle control device based on the route following functionality. In a second operation, the steering wheel is controlled by the control device in such a way that the steering wheel is adjusted according to the target angle via the steering wheel actuator. In a third operation, the steering wheel is adjustable by the driver with an additional driver torque to a different steering wheel angle. In a fourth operation, a steering wheel angle is detected by the steering wheel sensor. In a fifth operation, the steering wheel is subjected to feedback torque by the control device via the steering wheel actuator. The feedback torque depends on a difference between the actual steering wheel angle and the target angle. In a sixth operation, a target road wheel angle for at least one steerable road wheel of the vehicle is determined by the control device based on the steering wheel angle. In a seventh operation, a control signal for the road wheel actuator corresponding to the desired road wheel angle is determined by the control device and output to the road wheel actuator.

The example method is based on the knowledge that the driver can apply additional driver torque to the steering wheel and thus move the steering wheel to a different steering wheel angle than the target angle. This means that the steering wheel can be moved both by the autonomous or semi-autonomous path following functionality, and also simultaneously by the driver of the vehicle in a manual manner. This enables cooperative control of the lateral control of the vehicle.

In some examples, torque applied by the steering wheel actuator may be limited by the control device. This simplifies the application of additional driver torque to the steering wheel. In addition, the fact that the feedback torque depends on the difference between the steering wheel angle and the target angle creates gentle but divergence-dependent feedback for the driver at the steering wheel regarding the divergence from the target angle. The greater the divergence from the target angle, the greater the feedback and the more likely the driver is to be driven towards the target angle based on the feedback torque. If the driver still wants to diverge from the target angle, this is still possible, but with increasing divergence, a higher effort (e.g., higher driver torque) is required.

In some examples, the feedback torque can be proportional to the difference between the steering wheel angle and the target angle. In some examples, the feedback torque can also be a non-linear function of the difference between the steering wheel angle and the target angle. In some examples, the function is such that a higher difference between the steering wheel angle and the target angle also generates a higher feedback torque.

The described example method enables precise, adjustable and consistent tuning of the control device. This allows the torque control to be configured regarding the feedback torque so that the driver is at the same time returned to the target angle desired by the route following function, provided the driver first deviates from it by providing additional torque. The example method provides a consistent and natural feedback behavior for the driver during the cooperative control mode. This increases the comfort for the driver of the vehicle compared to previous approaches.

Further, examples described herein provide a SBW steering system for a vehicle. The SBW steering system includes at least one steering wheel, a steering wheel actuator coupled to the steering wheel, a steering wheel sensor, a road wheel actuator coupled to at least one steerable road wheel of the vehicle and a control device. The control device is at least coupled with the steering wheel actuator, the steering wheel sensor and the road wheel actuator. The control device executes at least one algorithm for controlling the steering wheel actuator and for regulating the road wheel actuator and is coupled with a vehicle control device.

The vehicle control device is configured to perform at least a semi-autonomous or fully automatic route following function. The control device is at least configured to receive a target angle for the steering wheel from the vehicle control device and control the steering wheel in such a way that the steering wheel is adjusted according to the target angle via the steering wheel actuator, whereby the steering wheel can be adjusted by the driver to a different steering wheel angle with an additional driver torque. The steering wheel sensor is configured to detect a steering wheel angle of the road wheel to which it is assigned.

The control device is also configured to apply feedback torque to the steering wheel via the steering wheel actuator. The feedback torque depends on a difference between the steering wheel angle and the target angle. The control device is further configured to determine a target road wheel angle for at least one steerable road wheel based on the steering wheel angle, determine a control signal for the road wheel actuator corresponding to the target road wheel angle, and output the control signal to the road wheel actuator. The advantages achieved by the example method described herein are also achieved in a corresponding manner by the SBW steering system.

The SBW steering system of the vehicle is to be understood as the conventional SBW steering system of the vehicle and not an auxiliary steering system which is made possible by torque control with regard to drive units and/or deceleration devices assigned to the respective road wheels. In this context, the drive units here are to be understood as correspondingly operated electric motors, each of which is assigned to at least one road wheel and serves to drive the vehicle and not to guide the vehicle laterally. Rather, the drive units of the vehicle are separate from the road wheel actuators and their electric motors.

The SBW steering system includes at least one road wheel actuator coupled to at least one steerable road wheel. In some examples, the road wheel actuator can also be coupled with several steerable road wheels, for example via a rack.

In some examples, the vehicle may include several road wheel actuators, each individually coupled with several steerable road wheels. This increases the configurability of the SBW steering system.

In some examples, the vehicle may also include separate individual road wheel actuators regarding at least some of the vehicle's steerable road wheels. This means that the corresponding steerable road wheels can be controlled independently of other steerable road wheels for the lateral control of the vehicle according to individual road wheel orientations. This makes it possible, for example, for individual steerable road wheels to have different orientations, for example a toe-in position or a toe-out position with respect to a track position defined by the steering wheel angle of the steering wheel. This means that the corresponding steerable road wheels intentionally diverge from the track position, which corresponds to the driver's steering input and/or the following functionality. This can be advantageous, for example, if individual road wheels of the vehicle have a high level of slippage, for example due to the ground conditions (e.g., during off-road driving or similar).

In some examples, the lateral control of the vehicle can be based, at least in part, on the driver's steering input, which he applies to the steering wheel, for example, to steer the vehicle in a specific direction. In some examples, the lateral control of the vehicle can also be based on the following functionality of the vehicle control device. The following functionality regulates the lateral control of the vehicle in a semi-autonomous or autonomous manner, whereby the driving control of the vehicle is exercised in such a way that a destination predefined or determined by the driver is reached. Typically, the route following functionality makes use of environmental data and/or position data and/or vehicle data, which are recorded via environmental sensors and/or a speed and/or speed change sensor of the vehicle or determined via a position signal receiver. For example, the route following functionality can steer the vehicle according to the course of the road and adjust the lateral control of the vehicle for this purpose. Based on the following function, there is therefore a target angle for each control interval, according to which the steering wheel of the vehicle is to be controlled so that the vehicle follows the intended trajectory determined by the following function. This target angle is then transmitted from the following functionality of the driving control device to the control device of the SBW steering system as a target angle requirement.

In some examples, the route following functionality can also be used to perform other comfort functions, such as a lane departure warning system or similar. The additional comfort functions can also have an influence on the lateral control of the vehicle, for example, to prevent the vehicle from unintentionally changing lanes.

The steering wheel actuator is configured to apply torque to the steering wheel, at least indirectly, for example via a steering column coupled to the steering wheel. The torque generated by the steering wheel actuator is also used to provide torque feedback to the driver via the vehicle's lateral control. In general, the steering wheel actuator includes an electric motor to apply the torque to the steering wheel. For example, the electric motor can include a winding set with three windings (e.g.,. a three-phase winding set). In some examples, the electric motor can also include more than one winding set.

The steering wheel sensor is configured to detect a steering wheel angle with respect to a reference position, such as a zero position (e.g., corresponding to a straight line). In some examples, the steering wheel sensor can also be configured to detect a steering wheel speed during rotation. The steering wheel sensor transmits the recorded measurement data to the control device. The steering wheel sensor can be directly coupled to the steering wheel, but can also be coupled to the steering column, as the steering column is rigidly coupled to the steering wheel and a rotation of the steering wheel thus translates directly into a rotation of the steering column.

The SBW steering system can also include a wheel angle sensor. The wheel angle sensor is assigned to at least one steerable road wheel of the vehicle and is configured to directly or indirectly detect a wheel angle of the assigned road wheel around the vehicle's vertical axis. In addition, the wheel angle sensor is coupled to the control device and configured to transmit recorded measured values to the control device. The detected wheel angle of the steerable road wheel can be used to precisely characterize the vehicle's condition, for example regarding the lateral speed change of the vehicle. In addition, based on the wheel angles detected by the wheel angle sensor, the control device can determine whether the vehicle is being guided according to the desired steering input. The wheel angle sensor can also be part of the road wheel actuator, for example as a position sensor that detects the position of the rack.

In addition, a wheel speed sensor may be provided, which can be used to determine the vehicle speed of the vehicle by the control device, at least indirectly, based on the recorded measured values. This allows the vehicle configuration of the respective driving conditions to be precisely characterized by the control device. Based on the recorded speeds, the control device can determine the wheel-specific slippage, for example. Wheel slip refers to the divergence of the wheel tread according to the wheel speed from the driving surface with which the respective wheel is in frictional contact, whereby a tangential force counteracts the traction. Traction means the transfer of the tractive force to drive the vehicle to the ground. A certain amount of wheel slip occurs when the vehicle is powered, for example depending on the surface conditions and the type of road wheels. However, if the wheel slip becomes too great, the vehicle can no longer be guided precisely measured against the steering input of the steering wheel.

For example, the vehicle can also be characterized in terms of its prevailing speed change values at a specific point in time. These parameters are then considered by the control device when determining the correct feedback torque to be applied from the steering wheel actuator to the steering wheel to give the driver of the vehicle feedback regarding the lateral control of the vehicle. Other parameters that can be considered by the control device when determining the correct feedback torque include, but are not limited to, measured or estimated recovery torques of the road wheels and/or the rack and pinion force exerted by the road wheel actuator on the rack.

The algorithm for controlling the steering wheel actuator and regulating the road wheel actuator can include at least one control loop with feedback. This means that the control device can include at least one control loop to manage the rotation of the steering wheel according to the target angle requirements of the following functionality. Then, as part of the algorithm, the control device also considers the steering wheel angle detected by the steering wheel sensor regarding a reference position (e.g., a zero position corresponding to a straight line). Based on a comparison of the steering wheel angle with the target angle requirement, a control signal is determined that is output to the steering wheel actuator to cause an adjusted rotation of the steering wheel.

In some examples, the control device returns the steering wheel to the target angle via the steering wheel actuator, provided that a driver stops applying additional driver torque. This creates a defined transition of the cooperative control when the manual operation of the steering wheel is stopped. As a result, the transition between the configuration of simultaneous manual and autonomous control of the steering wheel and the configuration of an exclusively autonomous control of the steering wheel is smooth and fluid. Thus, the lateral control of the vehicle does not show any abrupt changes, which increases the comfort of the driver of the vehicle.

In some examples, the feedback torque is limited based on a maximum allowable feedback torque of an electric motor of the steering wheel actuator. This prevents the electric motor from overstraining the steering wheel actuator. In addition, limiting the feedback torque also allows the driver to apply a torque to the steering wheel to influence the steering wheel angle.

In general, the maximum permissible feedback torque within the control system can be configured using the control device and/or the steering wheel actuator, for example in software. A distinction must be made between this and the maximum available feedback torque that the steering wheel actuator can apply, which is regularly higher than the maximum permitted feedback torque. The maximum permissible feedback torque is lower as to not put too much strain on the steering wheel actuator and to limit feedback torque in such a way that the driver can comfortably overcome the feedback torque.

The limitation of the feedback torque may be such that the force that a driver of the vehicle can typically apply is sufficient to overrule the feedback torque. This ensures that the driver can adjust the steering wheel divergent from the autonomous control according to a steering wheel angle desired by the driver.

In some examples, the control device adjusts the target angle of the steering wheel to a corrected target angle if the feedback torque required by the control system is greater than the maximum allowable feedback torque during the driver's applied torque. This prevents the steering wheel from jumping back abruptly when releasing. In some examples, the feedback torque is measured by the difference between the steering wheel angle and the target angle. In some examples, as explained earlier, feedback torque is generally limited. This can lead to the difference between the steering wheel angle and the original target angle would require such a high feedback torque that it exceeds the limit of the feedback torque. If the driver steers the steering wheel so far away from the target angle that the difference between the steering wheel angle and the target angle would cause a feedback torque that exceeds the maximum allowable feedback torque, the difference between the maximum allowed feedback torque and the feedback torque requested by the controller is determined as delta torque. In this situation, the target angle is adjusted based on the delta torque to obtain a corrected target angle. As a result, the feedback torque specified by the difference decreases. This leads to the feedback torque being less than the limit. This ensures that the corrected target angle follows the angle specified by the driver (e.g., the target angle). If the driver releases the steering wheel and no longer applies any driver torque to the steering wheel, the corrected target angle is close to the steering wheel angle (e.g., the angle of rotation). As a result, the steering wheel does not suddenly move to the target angle when the driver releases the steering wheel, but is gently guided to the corrected target angle.

In some examples, the adjustment of the target angle can be performed using a PID controller or similar, whereby the delta torque is subtracted from the corrected target angle over a time interval. As a result, the change in the steering wheel angle is relatively slow. Determining the corrected target angle based on the delta torque may depend on additional parameters, such as the distance between the target angle and the corrected target angle, or the rate of change of the target angle.

In some examples, the control device can determine a target angle difference (e.g., a delta reset angle) between the corrected target angle and the target angle. To adjust the control of the steering wheel back to the target angle without exceeding the maximum allowable feedback torque of the electric motor, the target angle difference is subtracted from the corrected target angle over the time interval, so that the return to the target angle is completed after the time interval. As a result, the corrected target angle slowly moves back to the target angle.

The feedback of the target angle can also be performed by a PID controller of the control device. The target angle difference that is subtracted from the corrected target angle may be limited to ensure smooth, continuous and fluid control of the steering wheel. This increases the comfort for the driver of the vehicle when the vehicle is guided laterally. The angle subtracted in each time step of the time interval can alternatively be a constant angle value or a value dependent on the difference between the corrected target angle and the original target angle. In some examples, the added angle can also be added at any time (e.g., regardless of whether the feedback torque reaches the maximum permissible reset torque). The control device configured in this way enables the behavior of the control device and the way in which the steering wheel returns to the target angle to be individually tuned via the control device. In addition, this prevents the control device from having to have large damping values.

In some examples, the control device causes the steering wheel actuator to return the steering wheel to the target angle based on a steering feel algorithm. The steering feel algorithm is also used in regulating the steering wheel according to the target angle in the case of exclusively manual steering. In manual control mode, when the driver releases the steering wheel, the steering feel algorithm returns the steering wheel to the center position (e.g., the steering wheel angle is equal to zero degrees). The measured steering wheel angle is included in the steering feel algorithm as the main variable. In some examples, the steering feel algorithm is configured in such a way that the feedback torque also increases with increasing distance to the center position. In general, the maximum allowable feedback torque calculated by the steering feel algorithm is so small that the driver can comfortably overdirect this feedback torque to deflect the steering wheel to a desired steering wheel angle according to a steering preference.

In the cooperative steering feel control mode, the target angle of the following functionality is subtracted from the detected steering wheel angle (e.g., rotation angle). The result is used in the steering feel algorithm instead of the unchanged steering angle. As a result, the steering feel algorithm will now return the steering wheel to the target angle of the following functionality when the steering wheel is released. If the driver steers the steering wheel away from the target angle of the following function, this also causes the feedback torque to increase relative to the deflection (e.g., the difference between the target angle of the following function and the detected steering wheel angle). Advantageously, this design ensures that typically no additional feedback torque limitation is required. This is made possible by the fact that the maximum permitted feedback torque is sufficiently low to allow the driver to overcome the feedback torque. The steering feel algorithm can be adjusted in terms of its parameters. This can influence the precision and feedback speed to the center position or the target angle of the following functionality in cooperative control mode when the driver releases the steering wheel.

The control device determines a wheel target angle for at least one steerable road wheel based on the steering wheel angle. The control device then issues a control signal to the road wheel actuator corresponding to the wheel target angle. As a result, the steering wheel angle is used for lateral control of the vehicle based on the steerable road wheels. Because the steering wheel angle can be adjusted both by the autonomous or semi-autonomous route following function of the vehicle control device and by the driver based on a corresponding driver torque, lateral control of the vehicle is made possible within the framework of the cooperative control of the steering wheel on the basis of two simultaneous input methods.

In some examples, the control device determines the wheel target angle at least based on a look-up table. In doing so, it also considers a detected or determined vehicle speed of the vehicle. By considering the speed of the vehicle, excessive steering movements of the vehicle are prevented based on an angle of adjustment of the steerable road wheels of the vehicle that does not correspond to the vehicle speed.

The vehicle speed can be determined using wheel speed sensors. In addition, the wheel angle sensors can be used to detect wheel angles of the steerable road wheels around a vehicle vertical axis and transmit them to the control device. Alternatively, or in combination, the vehicle speed can also be determined based on a receiving position signal. In another alternative, the vehicle speed can also be determined based on a speed and/or speed change sensor of the vehicle.

In some examples, the control device determines the wheel target angle at least based on the algorithm used to determine the wheel target angle in the case of exclusively manual steering (e.g., a manual control mode).

According to a further aspect, the disclosure also relates to a computer program product, comprising commands which, when executed by a computer, cause the computer to execute the method as described herein. The benefits achieved by the process described herein are also achieved in a corresponding manner by the computer program product.

According to an additional aspect, the disclosure also relates to a computer-readable storage medium, comprising commands which, when executed by a computer, cause the computer to execute the method as described herein. The advantages achieved by the process described herein are also achieved in a corresponding way by the computer-readable storage medium.

According to a further aspect, some examples of the disclosure relate to a vehicle with an SBW steering system as described herein or with an SBW steering system operable by the method as described herein. The advantages achieved by the procedure described herein are also achieved in a corresponding manner by the vehicle.

For the purposes of the disclosure, vehicles may include land vehicles, namely, inter alia, off-road and road vehicles such as passenger cars, buses, trucks and other commercial vehicles. Vehicles can be manned or unmanned. The vehicles are at least partially electrically driven (e.g., have an electric motor that serves as the drive). In addition, the vehicles can also have an optional combustion engine.

All the features explained regarding the various aspects can be combined individually or in (sub-)combination with other aspects.

The detailed description below, in conjunction with the accompanying drawings, in which the same numbers refer to the same elements, is intended as a description of different examples and is not intended to represent the only examples. Each example described in this disclosure is intended only as an example or illustration and should not be construed as favored or advantageous over other examples. The illustrative examples contained herein do not claim to be exhaustive and do not limit the claimed subject matter to the exact disclosed forms. Variations of the examples described are readily recognizable to the skilled person and the general principles defined herein can be applied to other examples and applications without departing from the spirit and scope of the examples described. Therefore, the examples described are not limited to the examples shown, but have the widest possible scope of application that is compatible with the principles and characteristics disclosed herein.

All the features disclosed below in relation to the examples and/or accompanying figures may be combined, alone or in any sub-combination, with features of the aspects of disclosure provided that the resulting combination of features is reasonable to a skilled person in the field of technology.

For the purposes of disclosure, the phrase "at least one of A, B and C" means, for example, (A), (B), (C), (A and B), (A and C), (B and C) or (A, B and C), including all other possible combinations if more than three elements are listed. In other words, the term "at least one of A and B" generally means "A and/or B", namely "A" alone, "B" alone or "A and B".

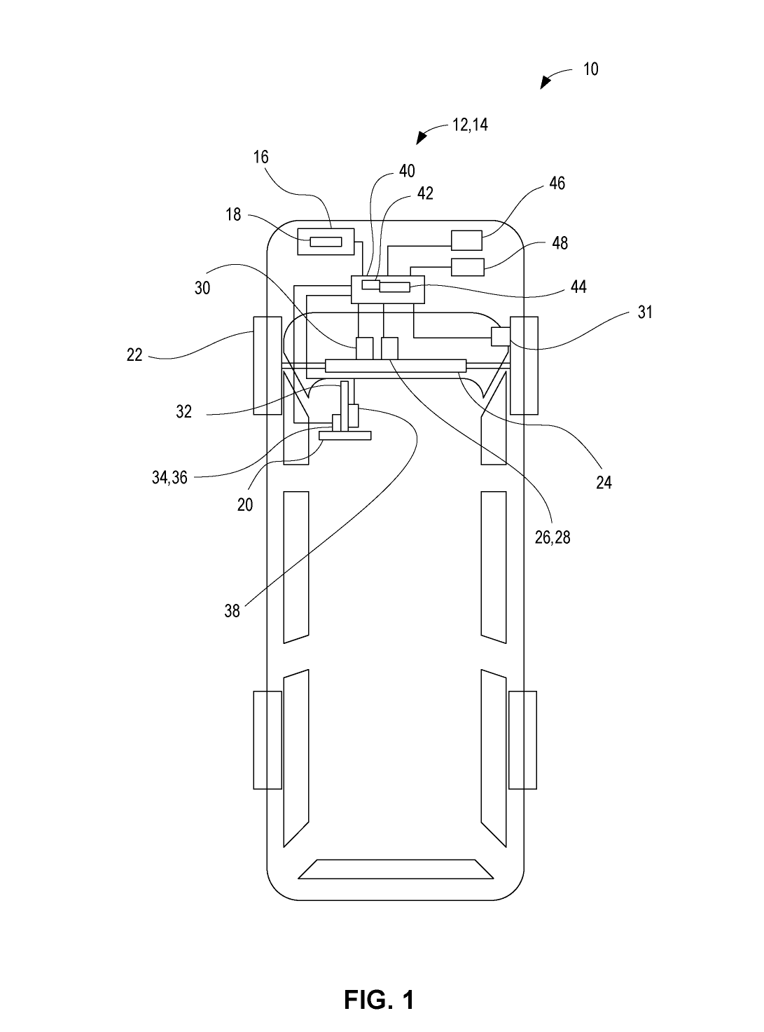

FIG. 1 shows a schematic representation of a vehicle 10 with a SBW steering system 12 according to examples described herein. The vehicle 10 includes an assembly 14, which includes both the SBW steering system 12 and at least a vehicle control device 16. Through the vehicle control device 16, at least one algorithm with the following function 18 is exercised. This means that based on a destination of the vehicle 10 to be reached, a trajectory for the vehicle 10 is determined by the algorithm with the route following function 18, for example according to a road on which the vehicle 10 is to be steered. As a result, the algorithm with the path following function 18 determines a target angle for the steering wheel 20 of the SBW steering system 12. The steering wheel 20 should therefore be deflected from a reference position according to the target angle so that lateral control of the vehicle 10 corresponds to the trajectory.

In addition to the SBW steering system 12, the vehicle 10 also includes steerable road wheels 22. The steerable road wheels 22 are coupled to a common rack 24. The common rack 24 can be moved from a reference position, for example a zero position, which causes a steering movement of the steerable road wheels 22. For example, the steerable road wheels 22 can be deflected starting from a straight alignment of the vehicle 10 so that the vehicle 10 performs a curve.

For the movement of the rack 24, the SBW steering system 12 includes a single road wheel actuator 26, which can jointly influence the alignment of both steerable road wheels 22 (e.g., front wheels) of the vehicle 10. In the illustrated example, the road wheel actuator 26 is coupled with the rack 24. In some examples, the road wheel actuator 26 can also be coupled to the steerable road wheels 22 in other ways to influence their orientation.

In some examples, several road wheel actuators 26 may also be provided, each individually coupled to a steerable road wheel 22. This has the advantage that the steerable road wheels 22 are not moved together, which means that the steerable road wheels 22 can be individually aligned. For example, individual steerable road wheels 22 can then take on dedicated off-track positions, for example for specific driving conditions (e.g., off-road driving). Off-track position means that the steerable road wheels 22 are not aligned according to a nominal track position, which is defined by the steering wheel angle of the steering wheel 20.

Even if not shown in the example of FIG. 1, the vehicle 10, the SBW steering system 12, and the assembly 14 can include other steerable road wheels 22, for example rear wheels that are coupled with an additional common rack or with individual road wheel actuators 26.

Each road wheel actuator 26 includes an electric motor 28. The electric motor 28 includes at least one winding set that includes a group of windings. Each winding set is configured so that phase currents can be used to drive a rotor of the electric motor 28. The rotor can then be coupled with a corresponding component of the SBW steering system 12, such as the rack 24, and thus enable the movement of the steerable road wheels 22. In general, the electric motor 28 can also have more than one winding set. Typically, each winding set is three-phase, so that the electric motor 28 is at least three-phase. If there are several winding sets, the winding sets allow the rotor of the electric motor 28 to move independently of other winding sets. This means that the winding sets are separate from each other.

In some examples, the vehicle 10 also includes wheel speed sensors 31, which can be used to record the rotational speeds of the road wheels 22 in the circumferential direction (e.g., the rolling direction). Based on the recorded speeds, for example, a wheel-specific slippage can be determined, which enables the characterization of the vehicle 10 according to the driving conditions. In some examples, each road wheel 22 is assigned a wheel speed sensor 31.

The SBW steering system 12 also includes wheel angle sensors 30. The wheel angle sensors 30 are configured to detect a wheel angle of the steerable road wheels 22 with respect to the vehicle's vertical axis and transmit it to a control device 40 of the SBW steering system 12 and/or the road wheel actuator 26. The wheel angle can also be detected indirectly by the wheel angle sensors 30, for example via a detected position of the rack 24. The wheel angle detected by the wheel angle sensors 30 can then be used, for example, by the control of the road wheel actuator 26.

Using the steering wheel 20, a driver of the vehicle 10 can make steering inputs to steer the vehicle 10 in a desired direction. The steering wheel 20 is coupled to a steering column 32 of the SBW steering system 12. The steering column 32 defines the axis of rotation around which the steering wheel 20 can be rotated. A steering wheel actuator 34 of the SBW steering system 12 is coupled to the steering wheel 20 via the steering column 32. The steering wheel actuator 34 includes an electric motor 36. The electric motor 36 of the steering wheel actuator 34 also includes at least one winding set. Each winding set is three-phase and configured to drive a rotor of the electric motor 36. As a result, feedback torque can be provided to the driver on the steering wheel 20 of the vehicle 10 by the electric motor 36 to give the driver feedback regarding the lateral control of the vehicle 10.

The SBW steering system 12 also includes at least one steering wheel sensor 38, which is at least indirectly coupled to the steering wheel 20, for example via the steering column 32. Each steering wheel sensor 38 is configured independently of other steering wheel sensors 38 to detect a driver's steering input based on a steering wheel angle (e.g., angle of rotation) and/or a steering wheel speed of the steering wheel 20 compared to a reference position. The steering wheel sensor 38 in the illustrated example of FIG. 1 is shown as coupled with the steering column 32, because the steering wheel 20 is rigidly coupled to the steering column 32, and a rotation of the steering wheel 20 thus translates directly into a rotation of the steering column 32. In general, the steering wheel sensor 38 can be coupled with the steering wheel 20 itself, for example with a basic component of the steering wheel 20, instead of with the steering column 32. In such examples, the steering wheel sensor 38 can directly detect the rotation of the steering wheel 20 itself.

The SBW steering system 12 also includes a control device 40 with a data processing device 42. The control device 40 is at least coupled with the vehicle control device 16, the road wheel actuator 26, the wheel angle sensor 30, the steering wheel actuator 34 and the steering wheel sensor 38. The data processing device 42 executes at least one algorithm 44 for the control of the steering wheel actuator 34 and for the control of the road wheel actuator 26. In addition, the control device 40 exerts an algorithm for regulating the steerable road wheels 22 and an algorithm for setting an appropriate feedback torque at the steering wheel 20.

The SBW steering system 12 is configured for cooperative control of the steering wheel 20. This means that the control device 40 can be used to output a corresponding control signal to the steering wheel actuator 34 to apply torque to the steering wheel 20 autonomously or semi-autonomously. At the same time, however, the steering wheel 20 is configured in such a way that the driver can apply additional driver torque to the steering wheel 20. Both the torque applied by the steering wheel actuator 34 and the torque applied by the driver cause a steering wheel angle of the steering wheel 20 to be adjusted. The steering wheel angle is detected by the steering wheel sensor 38, which is used by the control device 40 to set the steerable road wheels 22 according to the detected steering wheel angle. The control device 40 emits a corresponding control signal to the road wheel actuator 26, which causes a torque to align the steerable road wheels 22. The torque output by the road wheel actuator 26 can, for example, act on the rack 24, which then ultimately causes the alignment of the steerable road wheels 22. In examples where road wheel actuators 26 are assigned to respective steerable road wheels 22, each road wheel actuator 26 is transmitted a corresponding control signal from the control device 40.

In some examples, the vehicle 10 includes at least one position signal receiver 46 and a speed change sensor 48, which are also coupled with the control device 40. Via the position signal receiver 46, a position signal from a global navigation satellite system can be received so that the control device 40 can determine the position of the vehicle 10 based on the received position signal. For example, the speed of the vehicle 10 can also be determined indirectly from the position of the vehicle 10. Via the speed and speed change sensor 48, the vehicle speed and/or the speed change values of the vehicle 10 can be precisely detected along three orthogonally oriented directions and transmitted to the control device 40. As a result, the driving condition of the vehicle 10 can be precisely characterized by the control device 40 at a given control time.

In some examples, the control device 40 can consider other parameters of the vehicle 10 when issuing the control signal to a road wheel actuator 26, such as vehicle speed or speed change values. These values can also be considered when regulating the torque to be applied to the steering wheel 20 by the steering wheel actuator 34. In addition, the determined vehicle parameters indirectly recorded by the position signal receiver 46 and the speed and speed change sensor 48 can be considered by the vehicle control device 16 within the framework of the algorithm of the following function 18. In some examples, the SBW steering system 12 can include several components of the same type and generally the same function, for example several steering wheel sensors 38, thus ensuring redundancy.

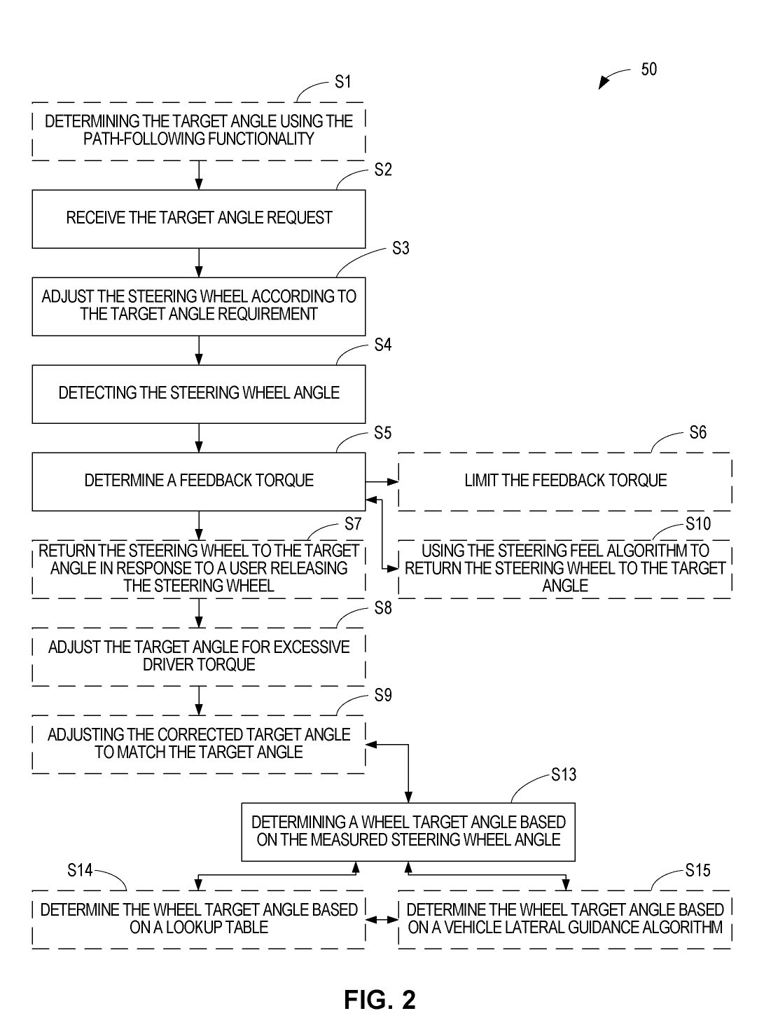

FIG. 2 shows a simplified schematic representation of a method 50 for the cooperative control of a SBW steering system 12 as part of the assembly 14 of the vehicle 10 according to an example. Optional operations are shown in dashed form.

In the optional operation S1 of method 50, a target angle is determined by the algorithm with the following function 18 of the driving control device 16. The target angle describes how to steer the vehicle 10 so that the vehicle 10 follows a fixed trajectory. The trajectory depends on a predefined destination of the vehicle 10. For example, the destination can be defined by a user input. To determine the target angle, the vehicle control device 16 can consider parameters of the environment of the vehicle 10, such as a road, and parameters of the vehicle 10 itself, such as a vehicle speed.

Method 50 then includes operation S2, in which the target angle is received by the control device 40 of the SBW steering system 12 from the vehicle control device 16 based on the algorithm with the following function 18. In other words, the vehicle control device 16 transmits a target angle requirement to the control device 40 so that it sets the steering wheel 20 according to the target angle determined by the vehicle control device 16.

In the following operation S3, the steering wheel 20 is controlled by the control device 40 so that the steering wheel 20 is adjusted according to the target angle via the steering wheel actuator 34. In some examples, a torque output of the steering wheel actuator 34 is limited by the control device 40. The steering wheel 20 can be adjusted by the driver to a different steering wheel angle with an additional driver torque. This means that the steering wheel actuator 34 can apply a maximum allowed torque to the steering wheel 20 via the electric motor 36 to set the steering wheel 20 according to the target angle defined by the target angle requirement. The limitation of the torque to be applied by the steering wheel actuator 34 simplifies the driver's influence on the application of driver torque. The driver can adjust the steering wheel angle via an additional driver torque on the steering wheel 20, and thus exert an additional manual influence on the lateral control of the vehicle 10 within the framework of the cooperative control of the steering wheel 20.

Operation S3 represents the control of the target angle requirement, the specific design of which is specified by operations S4 to S10.

The steering wheel angle of the steering wheel 20 is then detected by the steering wheel sensor 38 in operation S4 and transmitted to the control device 40.

Based on the steering wheel angle detected by the steering wheel sensor 38, the control device 40 then determines a feedback torque in operation S5. It then issues a corresponding actuator signal to the steering wheel actuator 34 so that it applies the feedback torque to the steering wheel 20. In such examples, the feedback torque is determined by the control device 40 based on a difference between the steering wheel angle of the steering wheel 20 detected by the steering wheel sensor 38 and the target angle. Feedback torque is a function of the difference between the steering wheel angle of the steering wheel 20 and the target angle. In some examples, the feedback torque is proportional to the difference. However, other dependencies can also be used. This means that the more the steering wheel angle diverges from the target angle, the greater the feedback torque and the more the steering wheel 20 is driven towards the target angle. This allows the driver to apply a manual driver torque to the steering wheel 20, thereby causing a divergence from the target angle. This enables continuous and fluid cooperative control of steering wheel 20 and thus the lateral control of the vehicle 10.

Operation S5 can be further implemented by the optional operation S6, in which the feedback torque detected by the control device 40 is limited to a maximum allowed feedback torque. This ensures that the driver is not prevented from setting a desired steering wheel angle due to excessive feedback torques.

In operation S7 of method 50, the control device 40 returns the steering wheel 20 to the target angle via the steering wheel actuator 34, provided that a driver releases a driver torque applied to the steering wheel 20. This means that the driver can apply a torque to control the steering wheel 20 which diverges the steering wheel angle from the target angle. However, if the driver stops or reduces the torque, the steering wheel 20 is returned in the direction of the target angle . This enables a smooth transition from the cooperative control mode of the steering wheel 20 by the driver and by the autonomous control using the algorithm 44 for the control of the steering wheel actuator 34 and the control of the road wheel actuator 26 of the control device 40 on the other.

Method 50 may then provide for an adjustment of the target angle of the steering wheel 20 by the control device 40 to a corrected target angle, in accordance with the optional operation S8, provided that the driver applies a torque to the steering wheel 20 in such a way that no feedback can be provided for a portion of the torque in the form of excessive torque, because the feedback torque corresponds to the maximum allowable feedback torque. The adjustment of the target angle of the steering wheel 20 is continued by the control device 40 until the feedback torque is less than the maximum allowable feedback torque of the electric motor 36 of the steering wheel actuator 34, which is the limitation of the feedback torque. For particularly high torques applied by the driver, the difference between the steering wheel angle detected by the steering wheel sensor 38 and the target angle increases. This results in an increase in the feedback torque, as the feedback torque is proportional to the difference. Because the feedback torque is limited based on the maximum feedback torque allowed by the electric motor 36 of the steering wheel actuator 34, if the driver applies excessive torque, no feedback torque corresponding to the excessive torque can be applied. In such examples, the control device 40 artificially adjusts the target angle so that the difference and thus the feedback torque are reduced.

In accordance with the subsequent optional operation S9 of method 50, the control device 40 aligns the corrected target angle established by the adjustment in operation S8 to the target angle. The control device 40 subtracts a delta angle value at each time step, depending on the difference between the corrected target angle and the target angle, until the corrected target angle corresponds to the target angle. Once the driver torque decreases and excessive torque is no longer exerted by the driver of the vehicle 10, the corrected target angle can be traced back to the target angle determined by the vehicle control device 16. To ensure that this transition is smooth and smooth, only a small adjustment to the corrected target angle takes place in a single time period. This means that the amount by which the corrected target angle is adjusted by the control device 40 in a single time period is limited. In some examples, the amount by which the corrected target angle can be adjusted in a single time period is predetermined. In some examples, the limit can be stored in a storage device that is coupled with the control device 40. In some examples, the limit can be specified by user input. This enables smooth feedback to the target angle, provided that excessive torque is no longer exerted by the driver of the vehicle 10. This increases comfort for the driver.

In some examples, the method 50 includes the optional operation S10, in which the control device 40 returns the steering wheel 20 to the target angle based on a steering feel algorithm via the steering wheel actuator 34. The steering feel algorithm is also used by the control device 40 in regulating the feedback torque to the driver in the case of exclusively manual steering. Due to an optional torque limiter corresponding to the optional operation S6, and because the steering feel algorithm normally requires only low torque, the feedback torque to the driver is limited. This means that the driver can apply additional driver torque to the steering wheel 20 to deviate from the control by the control device 40.

Here, the steering feel algorithm is extended in such a way that the algorithm of the control device 40 does not use the detected steering angle, but a value determined by subtracting the target angle from the steering wheel angle. As a result, the steering feel algorithm returns the steering wheel 20 to the target angle when the steering wheel 20 is released by the driver.

Method 50 also includes operation S13, in which the control device 40 determines a wheel target angle for at least one steerable road wheel 22 based on the steering wheel angle and outputs a control signal corresponding to the wheel target angle to the road wheel actuator 26. To detect the steering wheel angle of the steering wheel 20, the steering wheel sensor 38 can be used. Because the steering wheel angle of the steering wheel 20 is used to control the road wheel actuator 26, both input methods of the cooperative control of the steering wheel 20 are taken into account (e.g., the autonomous control on the basis of the control device 40 based on the vehicle control device 16 and a driver torque manually entered by the driver of the vehicle 10).

Operation S13 can be further implemented by the optional operation S14 in which the control device 40 determines the wheel target angle at least based on a lookup table. In doing so, the control device 40 considers a detected or determined vehicle speed of the vehicle 10. The vehicle speed can be determined by directly recorded parameters using the speed and speed change sensor 48 or based on a position of the vehicle 10 determined by the position signal receiver 46.

In some examples, operation S13 can be further implemented by the optional operation S15, in which the control device 40 determines the wheel target angle at least based on a vehicle lateral control algorithm. This vehicle lateral control algorithm defines a relationship between steering wheel angle and road wheel angle in manual driving.

Method 50 enables steering wheel 20 to be controlled for cooperative steering guidance through autonomous driving functions and manual inputs. The method 50 is configured in such a way that smooth transitions between the different input methods are substantially ensured. In addition, a smooth return is made possible if a manual entry is stopped. Furthermore, intrinsic adjustments are considered to counter excessive driver torques, so that faults, for example due to excessive feedback torque requirements for the steering wheel actuator 34, are prevented.

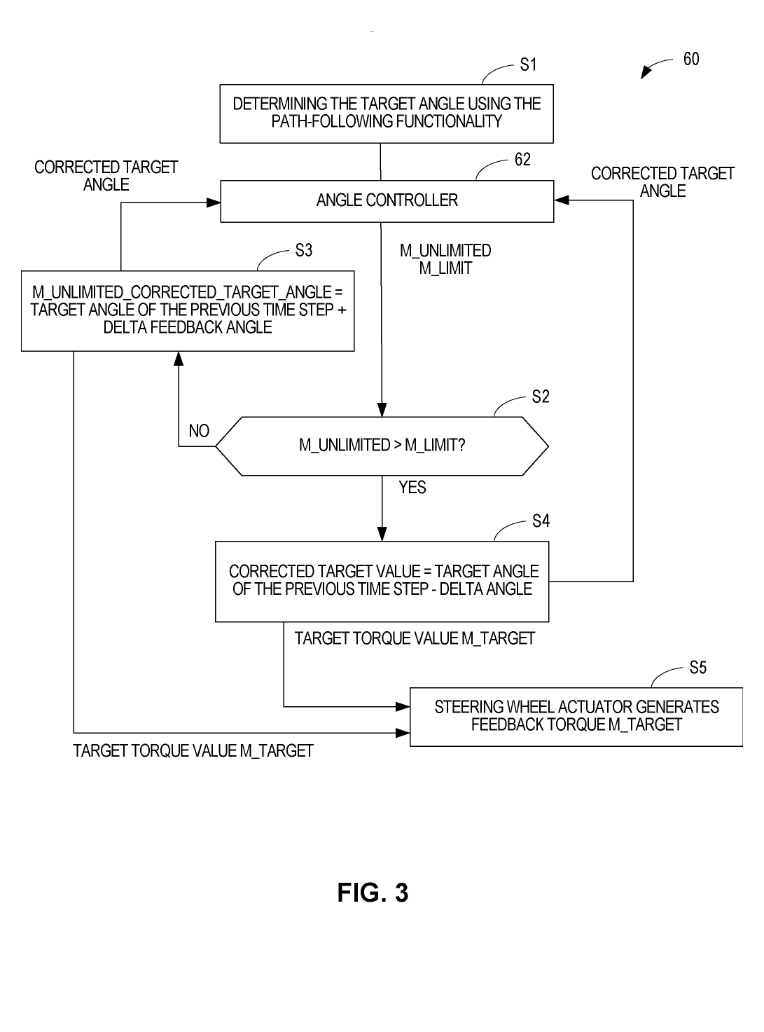

FIG. 3 shows an example implementation of target angle correction method 60. While in the illustrated example the method 60 is implemented by an angle controller 62, in some examples the method 60 can further be implemented by the control device 40, a PID controller, etc. The target angle correction method 60 includes operation S1, in which a target angle is initially determined and provided by the algorithm with the path following functionality 18 of the vehicle control device 16.

As a result of a difference between the steering wheel angle and the target angle, there is an unlimited torque target value (M_unlimited) for the feedback torque to be provided to the steering wheel 20. As part of the target angle correction method 60, the control device 40 now checks at operation S2 whether the unlimited torque target value is greater than the maximum permissible feedback torque (M_Limit) of the steering wheel actuator 34.

If this is not the case, the corrected target angle (M_unlimited_corrected_target_angle) is the target angle of the previous time interval, to which the delta feedback angle is added. The delta feedback angle corresponds to a portion of a target angle difference between the corrected target angle and the target angle. This results in a new value for the corrected target angle. In addition, the torque target value is fed to the steering wheel actuator 34, which generates the feedback torque and applies it to the steering wheel 20 in operation S5.

If the unlimited torque target value is greater than the maximum permitted feedback torque , a delta angle is determined by the target value correction method 60 at operation S4. The delta angle is determined by the difference between the unlimited torque target value and the maximum allowed feedback torque of the steering wheel actuator 34, which is multiplied by a factor. In such examples, the corrected target angle is the target angle of the previous time interval from which the delta feedback angle is subtracted. This results in a new value for the corrected target angle. In addition, the torque target value in such examples is the maximum permitted feedback torque. Again, the torque target value is fed to the steering wheel actuator 34, which generates the feedback torque and applies it to the steering wheel 20 at operation S5.

Example instructions and/or operations of FIGS. 2 and 3 may be implemented using executable instructions (e.g., computer-readable and/or machine-readable instructions) stored on one or more non-transitory computer-readable and/or machine-readable media. As used herein, the terms non-transitory computer-readable medium, non-transitory computer-readable storage medium, non-transitory machine-readable medium, and/or non-transitory machine-readable storage medium are expressly defined to include any type of computer-readable storage device and/or storage disk and to exclude propagating signals and to exclude transmission media. Examples of such non-transitory computer-readable medium, non-transitory computer-readable storage medium, non-transitory machine-readable medium, and/or non-transitory machine-readable storage medium include optical storage devices, magnetic storage devices, a hard disk drive (HDD), a flash memory, a read-only memory (ROM), a compact disc (CD), a digital versatile disc (DVD), a cache, a random-access memory (RAM) of any type, a register, and/or any other storage device or storage disk in which information is stored for any duration (e.g., for extended time periods, permanently, for brief instances, for temporarily buffering, and/or for caching of the information). As used herein, the terms “non-transitory computer-readable storage device” and “non-transitory machine-readable storage device” are defined to include any physical (mechanical, magnetic and/or electrical) hardware to retain information for a time period, but to exclude propagating signals and to exclude transmission media. Examples of non-transitory computer-readable storage devices and/ or non-transitory machine-readable storage devices include random-access memory of any type, read-only memory of any type, solid-state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer-readable instructions, machine-readable instructions, etc., and/or manufactured to execute computer-readable instructions, machine-readable instructions, etc.

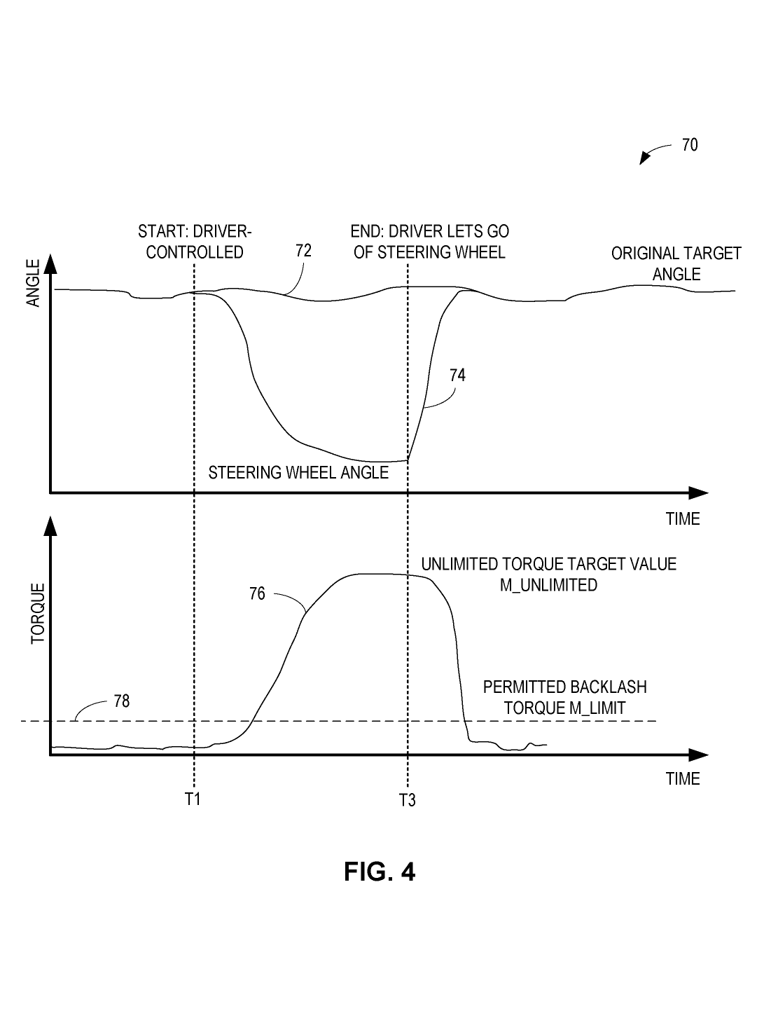

In connection with the target value correction method 60, FIG. 4 shows a schematic representation 70 of the angular and torque curve of a cooperative control without the target value correction method 60. The time is plotted on the x-axis. In the upper sub-diagram, the steering wheel angle is plotted on the y-axis and the torque on the y-axis in the lower sub-diagram.

Through the following function 18 of the driving control device 16, a target angle is determined and provided as the target angle 72. At time t1, the driver begins to apply additional driver torque to the steering wheel 20. This results in an actual steering wheel angle of 74, which differs from the original target angle of 72. In terms of torque, the driver torque results in an unlimited target torque value 76, which exceeds the maximum permissible feedback torque 78 of the steering wheel actuator 34. At time t3, the driver releases the steering wheel 20, which is why the actual steering wheel angle 74 is reduced to the target angle of 72 by the unlimited torque target value 76.

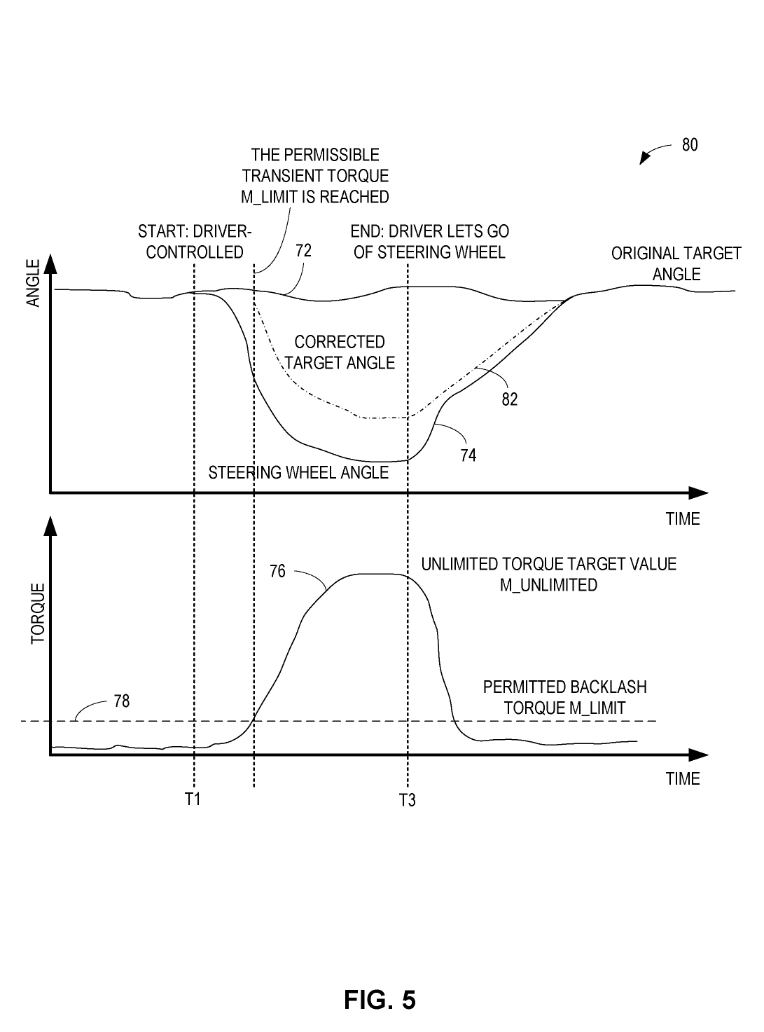

FIG. 5 shows a schematic representation 80 of the angular and torque curve of a cooperative control system with target value correction method 60. Only the differences from FIG. 4 will be discussed.

The unlimited torque target value 76 at time t2 exceeds the maximum permissible feedback torque 78 of the steering wheel actuator 34. The target value correction method 60 now applies an adjustment of the target angle to determine a corrected target angle 82. In such examples, the corrected target angle is 82 as the target angle of the previous control interval from which the delta reset angle is subtracted. The delta return angle corresponds to a portion of a target angle difference between the actual steering wheel angle 74 and the original target angle 72. As a result, the corrected target angle 82 differs from the original target angle 71 and also from the actual steering wheel angle 74.

After the driver releases the steering wheel 20, the corrected target angle 82 is returned to the original target angle of 72 based on the unlimited torque target value 76.

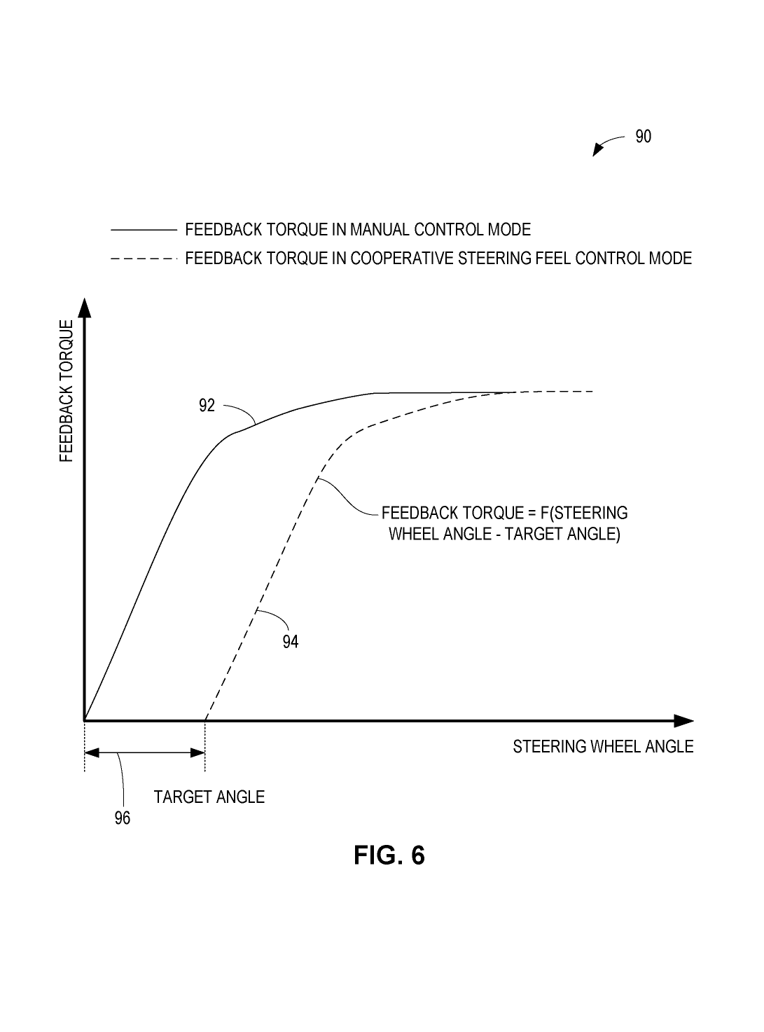

FIG. 6 shows a schematic representation 90 of torque curves in manual and cooperative steering feel control modes. In manual control mode, corresponding to operation S15 of the method 50, the feedback torque 92 to be applied by the steering wheel actuator 34 is shown. The target angle correction 96 to the corrected target angle 82, provided that the unlimited torque target value 76 exceeds the maximum permissible feedback torque 78 of the steering wheel actuator 34, results in an adjusted feedback torque curve 94. The feedback torque is a function of the difference between the actual steering wheel angle 74 and the target angle 72 of the following function 18. The functional dependence can be, for example, a proportionality to the difference, whereby a corresponding factor is considered to achieve a desired control behavior.

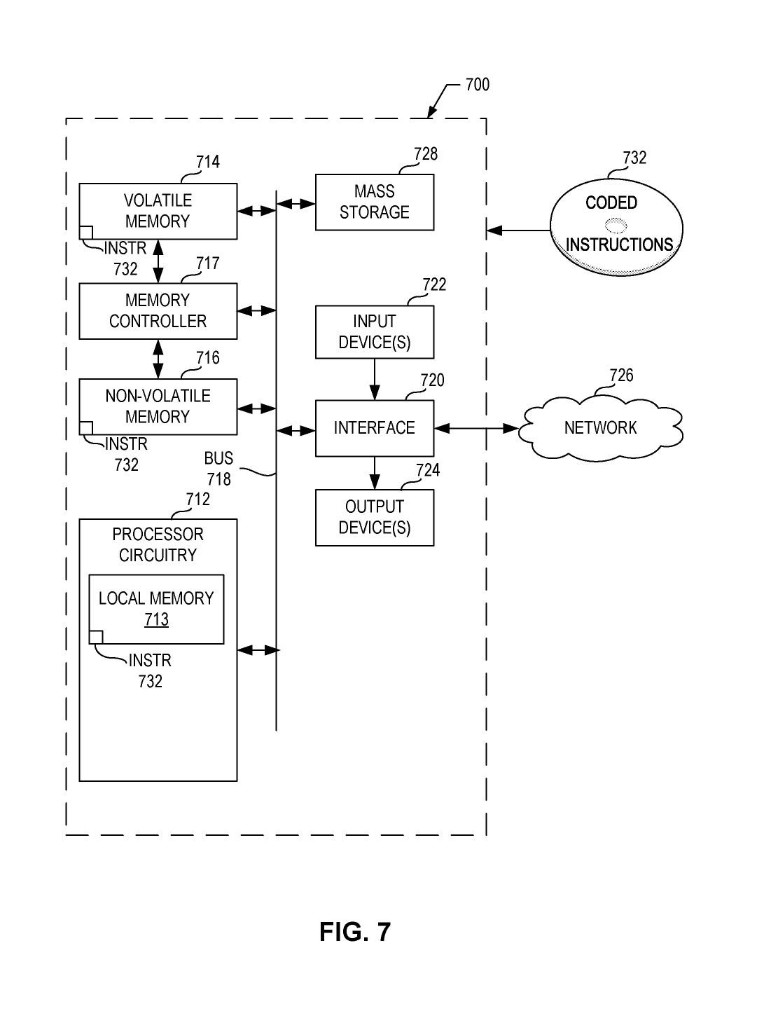

FIG. 7 is a block diagram of an example programmable circuitry platform 700 structured to execute and/or instantiate the example machine-readable instructions and/or the example operations of FIG. [Flowcharts] to implement examples disclosed herein. The programmable circuitry platform 700 can be, for example, a control device, an electronic control unit (ECU), a self-learning machine (e.g., a neural network), or any other type of computing and/or electronic device.

The programmable circuitry platform 700 of the illustrated example includes programmable circuitry 712. The programmable circuitry 712 of the illustrated example is hardware. For example, the programmable circuitry 712 can be implemented by one or more integrated circuits, logic circuits, field programmable gate arrays (FPGAs), microprocessors, central processor units (CPUs), graphics processor units (GPUs), vision processor units (VPUs), digital signal processors (DSPs), and/or microcontrollers from any desired family or manufacturer. The programmable circuitry 712 may be implemented by one or more semiconductor based (e.g., silicon based) devices.

The programmable circuitry 712 of the illustrated example includes a local memory 713 (e.g., a cache, registers, etc.). The programmable circuitry 712 of the illustrated example is in communication with main memory 714, 716, which includes a volatile memory 714 and a non-volatile memory 716, by a bus 718. The volatile memory 714 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 716 may be implemented by flash memory and/or any other desired type of memory device. Access to the main memory 714, 716 of the illustrated example is controlled by a memory controller 717. In some examples, the memory controller 717 may be implemented by one or more integrated circuits, logic circuits, microcontrollers from any desired family or manufacturer, or any other type of circuitry to manage the flow of data going to and from the main memory 714, 716.

The programmable circuitry platform 700 of the illustrated example also includes interface circuitry 720. The interface circuitry 720 may be implemented by hardware in accordance with any type of interface standard, such as a controller area network (CAN), an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 722 are connected to the interface circuitry 720. The input device(s) 722 permit(s) a user (e.g., a human user, a machine user, etc.) to enter data and/or commands into the programmable circuitry 712. The input device(s) 722 can be implemented by, for example, an audio sensor, a microphone, a camera (still or video), a button, a touchscreen, and/or a voice recognition system.

One or more output devices 724 are also connected to the interface circuitry 720 of the illustrated example. The output device(s) 724 can be implemented, for example, by display devices (e.g., a light emitting diode (LED), an organic light emitting diode (OLED), a liquid crystal display (LCD), an in-place switching (IPS) display, a touchscreen, etc.), a tactile output device, and/or speaker. The interface circuitry 720 of the illustrated example, thus, typically includes a graphics driver card, a graphics driver chip, and/or graphics processor circuitry such as a GPU.

The interface circuitry 720 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 726. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 700 of the illustrated example also includes one or more mass storage discs or devices 728 to store firmware, software, and/or data. Examples of such mass storage discs or devices 728 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or solid-state drives (SSDs).

The machine-readable instructions 732, which may be implemented by the machine-readable instructions of FIG. [Flowcharts], may be stored in the mass storage device 728, in the volatile memory 714, in the non-volatile memory 716, and/or on at least one non-transitory computer readable storage medium such as a CD or DVD which may be removable.

This disclosure can refer to quantities and numbers. Unless expressly stated, such quantities and numbers are not to be regarded as limiting, but as examples of the possible quantities or numbers in connection with the disclosure. In this context, the term "plural" can also be used in this disclosure to refer to a quantity or number. In this context, the term "plural" refers to any number that is greater than one, e.g. two, three, four, five, etc. The terms "approximately", "approximately", "near", etc. mean plus or minus 5% of the stated value.

Although the disclosure has been presented and described in relation to one or more examples, after reading and understanding this description and the accompanying drawings, the skilled person will be able to make equivalent changes and modifications.

Example methods and apparatus for the cooperative control of a steer-by-wire steering system are disclosed herein. Further examples and combinations thereof include the following:

Example 1 includes a steer-by-wire (SBW) steering system for a vehicle comprising a steering wheel, a steering wheel actuator coupled to the steering wheel, a road wheel actuator coupled to road wheels of the vehicle, machine readable instructions, and a control device to execute the machine readable instructions to determine a steering wheel angle of the steering wheel, cause the steering wheel actuator to apply a first feedback torque to the steering wheel based on the steering wheel angle and a target steering wheel angle, based on a user applied torque that is greater than the first feedback torque, cause the steering wheel actuator to apply a second feedback torque to the steering wheel based on the steering wheel angle, the target steering wheel angle, and the user applied torque, and cause the road wheel actuator to steer the vehicle based on the steering wheel angle.

Example 2 includes the SBW steering system of example 1, wherein if the user applied torque is greater than a maximum feedback torque of the steering wheel actuator, the control device is to cause the steering wheel actuator to apply a third feedback torque to the steering wheel based on the steering wheel angle, the user applied torque, and a corrected target steering wheel angle.

Example 3 includes the SBW steering system of example 2, wherein after the third feedback torque is applied, if the user applied torque is released, the control device causes the steering wheel actuator to apply a fourth feedback torque to the steering wheel over a time interval.

Example 4 includes the apparatus of any one or more of examples2-3, wherein the corrected target steering wheel angle is calculated based on the target steering wheel angle and a difference between the user applied torque and the maximum feedback torque.

Example 5 includes the apparatus of any one or more of examples 2-4, wherein the corrected target steering wheel angle is proportional to a difference between the user applied torque and the maximum feedback torque.

Example 6 includes the apparatus of any one or more of examples 1-5, wherein the target steering wheel angle is based on a predetermined destination of the vehicle.

Example 7 includes the apparatus of any one or more of examples 1-6, wherein the target steering wheel angle is based on an autonomous driving function of the vehicle.

Example 8 includes the apparatus of any one or more of examples 1-7, wherein the target steering wheel angle is based on at least a lookup table.

Example 9 includes a non-transitory computer readable medium comprising instructions to cause programmable circuitry to at least determine a steering wheel angle of a steering wheel of a vehicle, cause a steering wheel actuator of the vehicle to apply a first feedback torque to the steering wheel based on the steering wheel angle and a target steering wheel angle, based on a user applied torque that is greater than the first feedback torque, cause the steering wheel actuator to apply a second feedback torque to the steering wheel based on the steering wheel angle, the target steering wheel angle, and the user applied torque, and cause a road wheel actuator of the vehicle to steer the vehicle based on the steering wheel angle.

Example 10 includes the non-transitory computer readable medium of example 9, wherein if the user applied torque is greater than a maximum feedback torque of the steering wheel actuator, the programmable circuitry is to cause the steering wheel actuator to apply a third feedback torque to the steering wheel based on the steering wheel angle, the user applied torque, and a corrected target steering wheel angle.

Example 11 includes the non-transitory computer readable medium of example 10, wherein after the third feedback torque is applied, if the user applied torque is released, the programmable circuitry is to cause the steering wheel actuator to apply a fourth feedback torque to the steering wheel over a time interval.

Example 12 includes the apparatus of any one or more of examples 10-11, wherein the corrected target steering wheel angle is calculated based on the target steering wheel angle and a difference between the user applied torque and the maximum feedback torque.

Example 13 includes the apparatus of any one or more of examples 10-12, wherein the corrected target steering wheel angle is proportional to a difference between the user applied torque and the maximum feedback torque.

Example 14 includes the apparatus of any one or more of examples 9-13, wherein the target steering wheel angle is based on a predetermined destination of the vehicle.

Example 15 includes the apparatus of any one or more of examples 9-14, wherein the target steering wheel angle is based on an autonomous driving function of the vehicle.

Example 16 includes the apparatus of any one or more of examples 9-15, wherein the target steering wheel angle is based on at least a lookup table.

Example 17 includes a method for operating a steer-by-wire (SBW) steering system comprising determining a steering wheel angle of a steering wheel of a vehicle, causing a steering wheel actuator of the vehicle to apply a first feedback torque to the steering wheel based on the steering wheel angle and a target steering wheel angle, based on a user applied torque that is greater than the first feedback torque, causing the steering wheel actuator to apply a second feedback torque to the steering wheel based on the steering wheel angle, the target steering wheel angle, and the user applied torque, and causing a road wheel actuator of the vehicle to steer the vehicle based on the steering wheel angle.

Example 18 includes the method of example 17, wherein if the user applied torque is greater than a maximum feedback torque of the steering wheel actuator, further including causing the steering wheel actuator to apply a third feedback torque to the steering wheel based on the steering wheel angle, the user applied torque, and a corrected target steering wheel angle.

Example 19 includes the method of example 18, wherein after the third feedback torque is applied, if the user applied torque is released, further including causing the steering wheel actuator to apply a fourth feedback torque to the steering wheel over a time interval.

Example 20 includes the method of any one or more of examples 18-19, wherein the corrected target steering wheel angle is calculated based on the target steering wheel angle and a difference between the user applied torque and the maximum feedback torque.

What is claimed is:

1. A steer-by-wire (SBW) steering system for a vehicle comprising:
a steering wheel;
a steering wheel actuator coupled to the steering wheel;
a road wheel actuator coupled to road wheels of the vehicle;
machine readable instructions; and
a control device to execute the machine readable instructions to:
determine a steering wheel angle of the steering wheel;
cause the steering wheel actuator to apply a first feedback torque to the steering wheel based on the steering wheel angle and a target steering wheel angle;
based on a user applied torque that is greater than the first feedback torque, cause the steering wheel actuator to apply a second feedback torque to the steering wheel based on the steering wheel angle, the target steering wheel angle, and the user applied torque; and
cause the road wheel actuator to steer the vehicle based on the steering wheel angle.

2. The SBW steering system of claim 1, wherein if the user applied torque is greater than a maximum feedback torque of the steering wheel actuator, the control device is to cause the steering wheel actuator to apply a third feedback torque to the steering wheel based on the steering wheel angle, the user applied torque, and a corrected target steering wheel angle.

3. The SBW steering system of claim 2, wherein after the third feedback torque is applied, if the user applied torque is released, the control device causes the steering wheel actuator to apply a fourth feedback torque to the steering wheel over a time interval.

4. The SBW steering system of claim 2, wherein the corrected target steering wheel angle is calculated based on the target steering wheel angle and a difference between the user applied torque and the maximum feedback torque.

5. The SBW steering system of claim 2, wherein the corrected target steering wheel angle is proportional to a difference between the user applied torque and the maximum feedback torque.

6. The SBW steering system of claim 1, wherein the target steering wheel angle is based on a predetermined destination of the vehicle.

7. The SBW steering system of claim 1, wherein the target steering wheel angle is based on an autonomous driving function of the vehicle.

8. The SBW steering system of claim 1, wherein the target steering wheel angle is based on at least a lookup table.

9. A non-transitory computer readable medium comprising instructions to cause programmable circuitry to at least:
determine a steering wheel angle of a steering wheel of a vehicle;
cause a steering wheel actuator of the vehicle to apply a first feedback torque to the steering wheel based on the steering wheel angle and a target steering wheel angle;
based on a user applied torque that is greater than the first feedback torque, cause the steering wheel actuator to apply a second feedback torque to the steering wheel based on the steering wheel angle, the target steering wheel angle, and the user applied torque; and
cause a road wheel actuator of the vehicle to steer the vehicle based on the steering wheel angle.

10. The non-transitory computer readable medium of claim 9, wherein if the user applied torque is greater than a maximum feedback torque of the steering wheel actuator, the programmable circuitry is to cause the steering wheel actuator to apply a third feedback torque to the steering wheel based on the steering wheel angle, the user applied torque, and a corrected target steering wheel angle.

11. The non-transitory computer readable medium of claim 10, wherein after the third feedback torque is applied, if the user applied torque is released, the programmable circuitry is to cause the steering wheel actuator to apply a fourth feedback torque to the steering wheel over a time interval.

12. The non-transitory computer readable medium of claim 10, wherein the corrected target steering wheel angle is calculated based on the target steering wheel angle and a difference between the user applied torque and the maximum feedback torque.

13. The non-transitory computer readable medium of claim 10, wherein the corrected target steering wheel angle is proportional to a difference between the user applied torque and the maximum feedback torque.

14. The non-transitory computer readable medium of claim 9, wherein the target steering wheel angle is based on a predetermined destination of the vehicle.

15. The non-transitory computer readable medium of claim 9, wherein the target steering wheel angle is based on an autonomous driving function of the vehicle.

16. The non-transitory computer readable medium of claim 9, wherein the target steering wheel angle is based on at least a lookup table.

17. A method for operating a steer-by-wire (SBW) steering system comprising:
determining a steering wheel angle of a steering wheel of a vehicle;
causing a steering wheel actuator of the vehicle to apply a first feedback torque to the steering wheel based on the steering wheel angle and a target steering wheel angle;
based on a user applied torque that is greater than the first feedback torque, causing the steering wheel actuator to apply a second feedback torque to the steering wheel based on the steering wheel angle, the target steering wheel angle, and the user applied torque; and
causing a road wheel actuator of the vehicle to steer the vehicle based on the steering wheel angle.

18. The method of claim 17, wherein if the user applied torque is greater than a maximum feedback torque of the steering wheel actuator, further including causing the steering wheel actuator to apply a third feedback torque to the steering wheel based on the steering wheel angle, the user applied torque, and a corrected target steering wheel angle.

19. The method of claim 18, wherein after the third feedback torque is applied, if the user applied torque is released, further including causing the steering wheel actuator to apply a fourth feedback torque to the steering wheel over a time interval.

20. The method of claim 18, wherein the corrected target steering wheel angle is calculated based on the target steering wheel angle and a difference between the user applied torque and the maximum feedback torque.
